(19) United States
(12) Patent Application Publication
(10) Pub. No.: US 2024/0084972 A1
(43) Pub. Date: Mar. 14, 2024

(54) CO2 GAS-LIQUID PHASE TRANSITION-BASED MULTISTAGE COMPRESSION ENERGY STORAGE APPARATUS FOR CONVERTING THERMAL ENERGY INTO MECHANICAL ENERGY

(71) Applicant: EXA ENERGY TECHNOLOGY (SHENZHEN) CO. LTD., Guangdong (CN)

(72) Inventors: Yonghui XIE, Guangdong (CN); Qin WANG, Guangdong (CN); Lei SUN, Guangdong (CN); Yuqi WANG, Guangdong (CN); Di ZHANG, Guangdong (CN); Yongliang GUO, Guangdong (CN); Xiaoyong WANG, Guangdong (CN); Feng YANG, Guangdong (CN)

(21) Appl. No.: 18/273,637

(22) PCT Filed: Dec. 8, 2021
(86) PCT No.: PCT/CN2021/136442

§ 371 Date: Jul. 21, 2023

(30) Foreign Application Priority Data
Feb. 7, 2021 (CN) 202110169184.4

(51) Int. Cl. F17C 5/02; F17C 5/06

(52) U.S. Cl. CPC F17C 5/02; F17C 5/06; F17C 2221/013; F17C 2223/0123; F17C 2225/0153; F17C 2227/0157; F17C 2227/0185; F17C 2227/0388; F17C 2265/07

(57) ABSTRACT

A CO₂ gas-liquid phase transition-based multistage compression energy storage apparatus for converting thermal energy into mechanical energy, including: a gas storage; a liquid storage tank; an energy storage assembly, which includes compressors and energy storage heat exchangers; an energy release assembly (400), which includes energy release heat exchangers and expanders; a heat exchange assembly the energy generated by the energy storage assembly, and the energy release heat exchangers being capable of receiving the energy temporarily stored by the heat exchange assembly; and a driving assembly, which includes an energy input member and a first driving member, the energy input member absorbing external thermal energy to drive the first driving member to work, and the first driving member being used for driving the compressors to work.

### TECHNICAL FIELD

The present disclosure relates to the field of storing energy technology, in particular to a multi-stage compression energy storage device configured to convert thermal energy to mechanical energy based on CO₂ gas-liquid phase transition.

### BACKGROUND

With the development of social economy, people's demand for energy is increasing. Improving energy conversion efficiency can reduce the consumption of non-renewable traditional energy such as coal and oil, and bring significant economic benefits. It has become a mature technology to produce high-pressure steam power generation by utilizing the waste heat of high-temperature exhaust gas, waste steam and wastewater, and slag waste heat. However, the thermal energy generated by geothermal, solar thermal, biomass combustion and waste incineration need to be further developed and utilized.

With the large-scale use of new energy such as solar energy and wind energy, the consumption of traditional energy can be reduced to a certain extent, but the intermittent and volatile characteristics of its power generation will have a certain impact on the power grid. Storing energy technology is an important means to solve these problems, which is of great significance for the optimization and regulation of energy system. In the related art, there is a way to store energy by compressing carbon dioxide. Its main principle is to use excess electricity to compress carbon dioxide and store energy during the low power consumption period. In the peak period of power consumption, it is released, and the turbine drives the generator to output power, so as to effectively use electric energy and reduce the impact of intermittent power generation of new energy on the power grid. However, in the natural environment and industrial and agricultural production, there are many heat energy, such as geothermal, solar thermal, biomass combustion, waste incineration, etc., which are usually directly released into the environment, resulting in huge waste.

### SUMMARY

A multi-stage compression energy storage device configured to convert thermal energy to mechanical energy based on CO₂ gas-liquid phase transition is provided. External energy such as geothermal energy, photothermal energy, heat energy generated by waste incineration and waste heat generated in industrial production can be utilized by the device, so as to reduce resource waste and save energy.

A multi-stage compression energy storage device configured to convert thermal energy to mechanical energy based on CO₂ gas-liquid phase transition includes:
a gas storage reservoir configured to store gaseous carbon dioxide, and a volume of the gas storage reservoir being variable;
a liquid storage tank configured to store liquid carbon dioxide;
an energy storage assembly configured to store energy and provided between the gas storage reservoir and the liquid storage tank, wherein the energy storage assembly includes a condenser and at least two compression energy storage members, each compression energy storage member includes a compressor configured to compress the carbon dioxide and an energy storage heat exchanger, and the condenser is configured to condense the carbon dioxide;
an energy releasing assembly provided between the gas storage reservoir and the liquid storage tank and comprising an evaporator and at least one expansion energy releasing member, wherein the expansion energy releasing member includes an energy releasing heat exchanger and an expander, the evaporator is configured to evaporate the carbon dioxide, and the expander is configured to release energy;
a heat exchange assembly connected to the energy storage heat exchanger and the energy releasing heat exchanger, wherein the energy storage heat exchanger is configured to temporarily store the energy generated by the energy storage assembly into the heat exchange assembly, and the energy releasing heat exchanger is configured to receive the energy temporarily stored by the heat exchange assembly; and
a driving assembly comprising an energy input member and a first driving member, wherein the energy input member absorbs external heat energy to drive the first driving member to work, and the first driving member is configured to drive the compressor to work.

In an embodiment, the driving assembly further includes a second driving member connected to the compressor, when the first driving member is not activated, the second driving member is capable of driving the compressor to work.

In an embodiment, the compressors of the plurality of compression energy storage members are distributed along an axial direction of an output shaft of the first driving member.

In an embodiment, the driving assembly further includes a driving circulation cooler and a driving circulation pump; the energy input member, the first driving member, the driving circulation cooler, and the driving circulation pump form a driving circulation circuit, driving medium is provided in the driving circulation circuit, the driving circulation pump is configured to drive the driving medium to circulate in the driving circulation circuit, the driving medium absorbs the external heat energy through the energy input member and drives the first driving member to work, the driving circulation cooler is configured to cool the driving medium flowing out of the first driving member.

In an embodiment, the energy storage assembly includes a first compressor, a first energy storage heat exchanger, a second compressor, and a second energy storage heat exchanger, the first compressor is connected to the gas storage reservoir, the first energy storage heat exchanger is connected to the first compressor, the second compressor is connected to the first energy storage heat exchanger, and the second energy storage heat exchanger is connected to the second compressor, the condenser is connected to the second energy storage heat exchanger, and the liquid storage tank is connected to the condenser.

In an embodiment, the energy releasing assembly includes a first expander, a second expander, a first energy releasing heat exchanger, a second energy releasing heat exchanger and an energy releasing cooler, and the evaporator is connected to the liquid storage tank, the first energy releasing heat exchanger is connected to the evaporator, the first expander is connected to the first energy releasing heat exchanger, the second energy releasing heat exchanger is connected to the first expander, the second expander is connected to the second energy releasing heat exchanger, the energy releasing cooler is connected to the second expander, the gas storage reservoir is connected to the energy releasing cooler, and the energy releasing cooler is configured to cool the carbon dioxide in the gas storage reservoir.

In an embodiment, the energy releasing cooler is connected to the evaporator.

In an embodiment, the energy releasing assembly further includes a throttle expansion valve provided between the liquid storage tank and the evaporator, the throttle expansion valve is configured to depressurize the carbon dioxide flowing out of the liquid storage tank, and the evaporator is connected to the condenser.

In an embodiment, the heat exchange assembly includes a cold storage tank and a heat storage tank, and heat exchanging medium is provided in the cold storage tank and the heat storage tank, the cold storage tank and the heat storage tank form a heat exchanging circuit between the energy storage assembly and the energy releasing assembly, the heat exchanging medium is capable of flowing in the heat exchanging circuit, when the heat exchanging medium flows from the cold storage tank to the heat storage tank, the heat exchanging medium is capable of storing a part of the energy generated by the energy storage assembly, and when the heat exchanging medium flows from the heat storage tank to the cold storage tank, the stored energy is transferred to the energy releasing assembly.

In an embodiment, the heat exchange assembly further includes a heat exchanging medium cooler configured to cool the heat exchanging medium entering the cold storage tank, and the heat exchanging medium cooler is connected to the evaporator.

In an embodiment, an auxiliary heating member is provided between the cold storage tank and the heat storage tank, and a part of the heat exchanging medium is capable of flowing into the heat storage tank after being heated by the auxiliary heating member.

In an embodiment, the gas storage reservoir is a flexible gas film storage reservoir.

The multi-stage compression energy storage device configured to convert thermal energy to mechanical energy based on CO₂ gas-liquid phase transition provides the gas storage reservoir tank storing gaseous carbon dioxide and the liquid storage tank storing liquid carbon dioxide. The energy storage assembly and the energy releasing assembly are provided between the gas storage reservoir and the liquid storage tank, and the heat exchange assembly is further provided between the energy releasing assembly and the energy storage assembly. When the carbon dioxide flows from the gas storage reservoir to the liquid storage tank through the energy storage assembly, the carbon dioxide flowing out of the gas storage reservoir is compressed in multiple stages by multiple compressors. During the compression, the temperature and pressure of the carbon dioxide will increase, and the pressure energy is stored in the carbon dioxide, and heat is stored in the heat exchange assembly and transferred to the energy releasing assembly, and the energy is released through the energy releasing assembly. In the energy storage device, the waste heat generated in the manufacturing process can be supplied to the energy input member, so that the first driving member works, and then the compressor is driven to work through the first driving member, so as to recycle the heat energy, and when the energy is released, waste of heat energy is reduced and energy is saved.

### BRIEF DESCRIPTION OF THE DRAWINGS

FIG. 1 is a schematic view of a multi-stage compression energy storage device configured to convert thermal energy to mechanical energy based on CO₂ gas-liquid phase transition in an embodiment of the present disclosure.

FIG. 2 is a schematic view of a first driving member, a second driving member and a plurality of compressors in FIG. 1.

FIG. 3 is a schematic view of the multi-stage compression energy storage device configured to convert thermal energy to mechanical energy based on CO₂ gas-liquid phase transition in another embodiment of the present disclosure.

### REFERENCE NUMBERS

gas storage reservoir 100;
liquid storage tank 200;
energy storage assembly 300, first compressor 310, first energy storage heat exchanger 320, second compressor 330, second energy storage heat exchanger 340, condenser 350, first energy storage pipeline 361, second energy storage pipeline 362, third energy storage pipeline 363, fourth energy storage pipeline 364, fifth energy storage pipeline 365, sixth energy storage pipeline 366;
energy releasing assembly 400, an evaporator 410, first energy releasing heat exchanger 420, first expander 430, second energy releasing heat exchanger 440, second expander 450, energy releasing cooler 460, first energy releasing pipeline 471, second energy releasing pipeline 472, third energy releasing pipeline 473, fourth energy releasing pipeline 474, fifth energy releasing pipeline 475, sixth energy releasing pipeline 476, seventh energy releasing pipeline 477, eighth energy releasing pipeline 478, throttle expansion valve 480, first generator 491, second generator 492;
heat exchange assembly 500, cold storage tank 510, heat storage tank 520, heat exchange medium cooler 530, first heat exchange pipeline 541, second heat exchange pipeline 542, third heat exchange pipeline 543, fourth heat exchange pipeline 544, fifth heat exchange pipeline 545, sixth heat exchange pipeline 546, seventh heat exchange pipeline 547, eighth heat exchange pipeline 548, first heat exchange medium circulating pump 550, second heat exchange medium circulating pump 551;
first valve 610, second valve 620, third valve 630, fourth valve 640, fifth valve 650, sixth valve 660, seventh valve 6200;
auxiliary heating member 710, heating pipe 720;
driving assembly 800, energy input member 810, first driving member 820, driving circulation cooler 830, driving circulation pump 840, second driving member 850, first driving circulation pipeline 861, second driving circulation pipeline 862, third driving circulation pipeline 863, fourth driving circulation pipeline 864.

### DETAILED DESCRIPTION OF THE EMBODIMENTS

In order to make the above objects, features and advantages of the present disclosure more obvious and easier to understand, the specific embodiments of the present disclosure are described in detail below in combination with the accompanying drawings. Many specific details are set forth in the following description to facilitate a full understanding of the invention. However, the present disclosure can be implemented in many ways different from those described herein, and those skilled in the art can make similar improvements without violating the connotation of the invention. Therefore, the invention is not limited by the specific embodiments disclosed below.

In the description of the present disclosure, it should be understood that the terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, “circumferential direction” are based on the azimuth or position relationship shown in the attached drawings, which is only for the convenience of describing the present disclosure and simplifying the description, rather than indicating or implying that the device or element must have a specific azimuth, be constructed and operated in a specific azimuth, so it cannot be understood as a limitation of the present disclosure.

In addition, the terms “first” and “second” are only used for descriptive purposes and cannot be understood as indicating or implying relative importance or implicitly indicating the number of indicated technical features. Thus, the features defined with “first” and “second” may explicitly or implicitly include at least one of the features. In the description of the present disclosure, “multiple” means at least two, such as two, three, etc., unless otherwise expressly and specifically defined.

In the present invention, unless otherwise expressly specified and limited, the terms “mount”, “connect”, “contact”, “fix” and other terms should be understood in a broad sense, for example, they can be fixed connections, removable connections, or integrated. It can be mechanical connection or electrical connection. It can be directly connected or indirectly connected through an intermediate medium. It can be the connection within two elements or the interaction relationship between two elements, unless otherwise expressly limited. For those skilled in the art, the specific meaning of the above terms in the present disclosure can be understood according to the specific situation.

In the present invention, unless otherwise expressly specified and limited, the first feature “above” or “below” the second feature may be in direct contact with the first and second features, or the first and second features may be in indirect contact through an intermediate medium. Moreover, the first feature is “above” the second feature, but the first feature is directly above or diagonally above the second feature, or it only means that the horizontal height of the first feature is higher than the second feature. The first feature is “below” of the second feature, which can mean that the first feature is directly below or obliquely below the second feature, or simply that the horizontal height of the first feature is less than that of the second feature.

It should be noted that when a component is called “fixed to” or “set to” another component, it can be directly on another component or there can be a centered component. When a component is considered to be “connected” to another component, it can be directly connected to another component or there may be intermediate components at the same time. The terms “vertical”, “horizontal”, “up”, “down”, “left”, “right” and similar expressions used herein are for illustrative purposes only, and do not mean that they are the only embodiments.

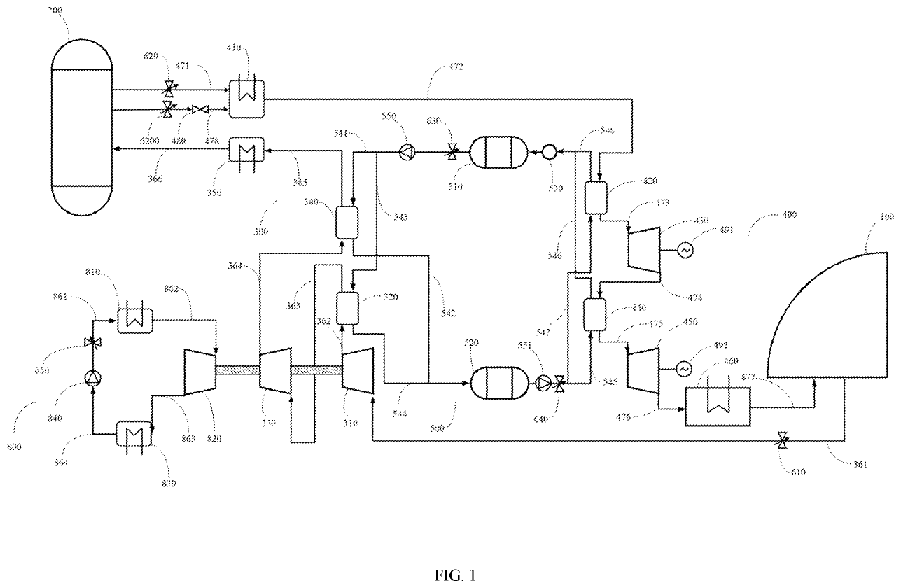

Referring to FIG. 1, FIG. 1 shows a schematic view of a multi-stage compression energy storage device configured to convert thermal energy to mechanical energy based on CO₂ gas-liquid phase transition in an embodiment of the present disclosure. The multi-stage compression energy storage device configured to convert thermal energy to mechanical energy based on CO₂ gas-liquid phase transition provided by an embodiment of the present disclosure includes a gas storage reservoir 100, a liquid storage tank 200, an energy storage assembly 300, an energy releasing assembly 400, a heat exchange assembly 500, a driving assembly 800, and other components.

Liquid carbon dioxide under high pressure is stored in the liquid storage tank 200. Gaseous carbon dioxide at normal temperature and pressure is stored in the gas storage reservoir 100, and the pressure and temperature inside the gas storage reservoir 100 are maintained within a certain range to meet the requirement of storing energy. Specifically, a thermal insulation device is provided to insulate the gas storage reservoir 100 to maintain its internal temperature within a required range. According to the ideal gas equation of state PV=nRT, when the temperature and pressure are constant, the volume is proportional to the amount of material. Therefore, the gas storage reservoir 100 adopts a gas film storage reservoir, and its volume can be changed. When carbon dioxide is introduced, the volume of the gas storage reservoir 100 increases, and when carbon dioxide flows out, the volume of the gas storage reservoir 100 decreases, so as to achieve a constant pressure in the gas storage reservoir 100. It should be noted that the pressure and temperature inside the gas storage reservoir 100 are maintained within the certain range, which is approximately regarded as a constant value in the above analysis.

Specifically, the temperature T1 in the gas storage reservoir 100 is in the range of 15° C.≤T1≤35° C., and the pressure difference between the air pressure in the gas storage reservoir 100 and the outside atmosphere is less than 1000 Pa.

The energy storage assembly 300 is located between the gas storage reservoir 100 and the liquid storage tank 200. The gaseous carbon dioxide flowing from the gas storage reservoir 100 is converted into liquid through the energy storage assembly 300, and the liquid flows to the liquid storage tank 200, during this process, the energy is stored.

Specifically, the energy storage assembly 300 includes a condenser 350 and at least two compression energy storage members, and each compression energy storage member includes a compressor and an energy storage heat exchanger. When carbon dioxide flows through the compressor, the carbon dioxide is compressed by the compressor to increase pressure of the carbon dioxide. During the compression process, heat is generated to increase the temperature of carbon dioxide. When the heat generated by compression flows through the energy storage heat exchanger with carbon dioxide, the energy is transferred to the heat exchange assembly 500 through the energy storage heat exchanger. The condenser 350 is configured to condense the compressed carbon dioxide into the liquid to be stored in the liquid storage tank 200.

The energy releasing assembly 400 is also located between the gas storage reservoir 100 and the liquid storage tank 200. The liquid carbon dioxide from the liquid storage tank 200 is converted into the gaseous carbon dioxide through the energy releasing assembly 400, and the gaseous carbon dioxide flows to the gas storage reservoir 100, during this process, the energy is released.

Specifically, the energy releasing assembly 400 includes an evaporator 410 and at least one expansion energy releasing member, which includes an expander and an energy releasing heat exchanger. When the carbon dioxide flows through the evaporator 410, the carbon dioxide is evaporated into the gaseous carbon dioxide, and then flows through the energy releasing heat exchanger. The gaseous carbon dioxide can absorb the energy temporarily stored at the heat exchange assembly 500 and the energy is released when the gaseous carbon dioxide flow through the expander.

The heat exchange assembly 500 is located between the energy storage assembly 300 and the energy releasing assembly 400. In the process of storing energy, a part of the stored energy is stored in the high-pressure liquid carbon dioxide in the form of pressure energy, and the other part of the stored energy is stored in the heat exchange assembly 500 in the form of heat energy. In the process of releasing energy, the energy stored in the heat exchange assembly 500 is transferred to the energy releasing assembly 400, and the stored energy is released through the carbon dioxide.

The driving assembly 800 is connected to the compressor of the energy storage assembly 300, and the driving assembly 800 includes an energy input member 810 and a first driving member 820. The energy input member 810 is connected to an external heat source and can absorb the heat energy provided by the external heat source. The heat energy input from the external heat source can drive the first driving member 820 to work, and then the compressor is driven to work through the first driving member 820.

The heat energy input member from the external heat source can be geothermal, photothermal, thermal energy generated by waste incineration, waste heat generated in the process of industrial production and other energy sources. By using the external heat source, energy waste can be reduced, and additional heating is not required, which can reduce costs.

In summary, in the driving assembly 800, the first driving member 820 is driven to work by the external heat energy absorbed by the energy input member 810, and the external heat energy is converted into mechanical energy, which drives the compressor to work.

In the energy storage device of the embodiment, the carbon dioxide in the gaseous state is converted to the carbon dioxide in the liquid state by inputting heat energy, and the energy is stored. In a peak period of power consumption, the stored energy is released to drive the generator to generate electric energy. In this way, energy waste can be reduced and the power generation burden of power plants can be reduced.

In the energy storage device of the embodiment, the carbon dioxide is only converted between the gaseous state and the liquid state, and before storing energy, the carbon dioxide is in the gaseous state and at normal temperature and pressure. Compared with the conventional storing energy and releasing energy by supercritical carbon dioxide, the requirement for the gas storage reservoir 100 in the embodiment is lower, and there is no need to provide complex storing components, which can reduce the cost.

One energy storage heat exchanger is correspondingly connected to one compressor, the two can be regarded as the compression energy storage member. A plurality of groups of compression energy storage members connected in sequence are provided between the gas storage reservoir 100 and the condenser 350. In this way, the carbon dioxide is gradually pressurized through multi-stage compression. The compressor in the compression energy storage member at the beginning is connected to the gas storage reservoir 100, the energy storage heat exchanger in the compression energy storage member at the end is connected to the condenser 350, and the energy storage heat exchanger in each group of compression energy storage members is connected to the compressor of adjacent compression energy storage member. The beginning and the end are defined in a direction from the gas storage reservoir 100 to the liquid storage tank 200 through the energy storage assembly 300.

In some embodiments, the energy storage assembly 300 includes a first compressor 310, a first energy storage heat exchanger 320, a second compressor 330, a second energy storage heat exchanger 340, the condenser 350, and other components. The first compressor 310 is connected to the gas storage reservoir 100 through a first energy storage pipeline 361, the first energy storage heat exchanger 320 is connected to the first compressor 310 through a second energy storage pipeline 362, the second compressor 330 is connected to the first energy storage heat exchanger 320 through a third energy storage pipeline 363, and the second energy storage heat exchanger 340 is connected to the second compressor 330 through a fourth energy storage pipeline 364, the condenser 350 is connected to the second energy storage heat exchanger 340 through a fifth energy storage pipeline 365, and the liquid storage tank 200 is connected to the condenser 350 through a sixth energy storage pipeline 366.

The heat exchange assembly 500 is connected to the first energy storage heat exchanger 320 and the second energy storage heat exchanger 340. Part of the energy generated during the first compressor 310 and the second compressor 330 compress carbon dioxide is stored in high-pressure carbon dioxide in the form of pressure energy, and part of the energy is transferred to the heat exchange assembly 500 for temporary storage in the form of heat energy through the first energy storage heat exchanger 320 and the second energy storage heat exchanger 340.

In the above structure, a two-stage compression is provided to gradually pressurize the carbon dioxide. Compared with one-time compression, the compressor with smaller compression ratio can be selected for two-time compression, and the cost of the compressor is lower. The number of compressors can also be more than two, as long as the compressor and energy storage heat exchanger are increased in complete sets.

One expander is correspondingly connected to one energy releasing heat exchanger, and the two can be regarded as the expansion energy releasing member. Preferably, a plurality of groups of expansion energy releasing members connected in sequence may be arranged between the evaporator 410 and an energy releasing cooler 460. In this way, the manufacturing requirements for the blades of the expander are lower, and accordingly, the cost is also lower. The energy releasing heat exchanger in the expansion energy releasing member at the beginning is connected to the evaporator 410, the expander in the expansion energy releasing member at the end is connected to the energy releasing cooler 460, and the expander in each expansion energy releasing member is connected to the energy releasing heat exchanger of adjacent expansion energy releasing member. The beginning and end are defined in a direction from the liquid storage tank 200 to the gas storage reservoir 100 through the energy releasing assembly 400. When there is only one group of expansion energy releasing member, the beginning and the end are the only group of expansion energy releasing member.

The energy releasing assembly 400 includes the evaporator 410, a first energy releasing heat exchanger 420, a first expander 430, a second energy releasing heat exchanger 440, a second expander 450, the energy releasing cooler 460, and other components. The evaporator 410 is connected to the liquid storage tank 200 through a first energy releasing pipeline 471, the first energy releasing heat exchanger 420 is connected to the evaporator 410 through a second energy releasing pipeline 472, the first expander 430 is connected to the first energy releasing heat exchanger 420 through a third energy releasing pipeline 473, the second energy releasing heat exchanger 440 is connected to the first expander 430 by a fourth energy releasing pipeline 474, the second expander 450 is connected to the second energy releasing heat exchanger 440 through a fifth energy releasing pipeline 475, the energy releasing cooler 460 is connected to the second expander 450 through a sixth energy releasing pipeline 476, and the gas storage reservoir 100 is connected to the energy releasing cooler 460 by a seventh energy releasing pipeline 477.

The heat exchange assembly 500 is connected to the first energy releasing heat exchanger 420 and the second energy releasing heat exchanger 440. In the process of releasing energy, the energy temporarily stored in the heat exchange assembly 500 is transferred to the carbon dioxide flowing through the first energy releasing heat exchanger 420 and the second energy releasing heat exchanger 440 through first energy releasing heat exchanger 420 and the second energy releasing heat exchanger 440. The carbon dioxide absorbs the energy and the energy is released through the first expander 430 and the second expander 450.

In the energy releasing assembly 400, when the gaseous carbon dioxide flows through the first expander 430 and the second expander 450, the gaseous carbon dioxide impacts the blades and drives the rotor to rotate, so as to output energy to drive the generator to generate electricity.

In the above structure, two expanders are provided to release energy twice. When two expanders are provided to release energy together, the manufacturing requirement for the blades of the expander are lower, and accordingly the cost is lower. The number of expanders can also be one, or more than two, as long as the expanders and energy releasing heat exchangers are increased or decreased in complete sets.

The heat exchange assembly 500 includes a cold storage tank 510, a heat storage tank 520, a heat exchange medium cooler 530, and other components. The heat exchanging medium is stored in the cold storage tank 510 and the heat storage tank 520. The cold storage tank 510 and the heat storage tank 520 form a heat exchanging circuit between the energy storage assembly 300 and the energy releasing assembly 400, and the heat exchanging medium can circulate in the heat exchanging circuit. The heat exchanging medium can be molten salt or saturated water, and the like.

The temperature of the heat exchange medium in the cold storage tank 510 is relatively low, and the temperature of the heat exchange medium in the heat storage tank 520 is relatively high. When the heat exchanging medium flows between the cold storage tank 510 and the heat storage tank 520, the energy can be collected and released. Specifically, when the heat exchanging medium flows from the cold storage tank 510 to the heat storage tank 520, a part of the energy generated in the process of storing energy is absorbed. When the heat exchanging medium flows from the heat storage tank 520 to the cold storage tank 510, the absorbed energy is released again. When the heat exchanging medium flows from the heat storage tank 520 to the cold storage tank 510, the heat exchanging medium flows through the heat exchange medium cooler 530 to be cooled, so as to meet the requirement of the temperature of the heat exchanging medium stored in the cold storage tank 510.

The driving assembly 800 includes an energy input member 810, a first driving member 820, a driving circulation cooler 830, a driving circulation pump 840, and other components. The energy input member 810, the first driving member 820, the driving circulation cooler 830 and the driving circulation pump 840 form a driving circulation circuit. Driving medium is provided in the driving circulation circuit. The driving circulation pump 840 can pressurize the driving medium, which is equivalent to a small-scale compressor, and the driving medium can be circulated in the driving circulation circuit under the driving of the driving circulation pump 840. The energy input member 810 is connected to an external heat source, and the energy input member 810 is connected to the driving circulation pump 840 through a first driving circulation pipeline 861. The first driving member 820 is connected to the energy input member 810 through a second driving circulation pipeline 862, and the driving cycle cooler 830 is connected to the first driving member 820 through a third driving circulation pipeline 863, and the driving cycle pump 840 is connected to the driving circulation cooler 830 though a fourth driving circulation pipeline 864.

The above-mentioned driving medium can be carbon dioxide, water vapor or other organic working medium. The selection of the driving medium is related to the temperature that can be provided by the external heat source connected to the energy input member 810. The first driving member 820 is a turbine. The driving medium is pressurized by the driving circulation pump 840 and absorbs external heat energy. When the high-temperature and high-pressure driving medium flows through a rotor of the turbine, the driving medium impacts the blade and drives the rotor to rotate, thereby driving a shaft of the turbine to rotate, so as to drive the first compressor 310 and the second compressor 330 to work.

In the above process, the input heat energy is converted to mechanical energy to drive the first compressor 310 and the second compressor 330 to work, and then the carbon dioxide is compressed by the first compressor 310 and the second compressor 330, and pressure energy and the heat energy are generated during compression to be stored.

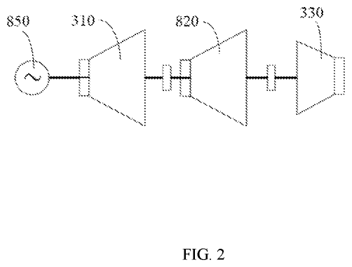

Referring to FIG. 1 and FIG. 2, FIG. 2 shows a schematic diagram of the first driving member, the second driving member and a plurality of compressors in FIG. 1. Since it takes some time for the energy input member part 810 in the driving assembly 800 to absorb external heat energy and drive the first driving member part 820 to work, if the driving assembly 800 and other components are activated at the same time, the first driving member 820 cannot drive the first compressor 310 and the second compressor 330 when they are just started. Therefore, a second driving member 850 is provided. When the device just starts to operate, the first compressor 310 and the second compressor 330 are driven by the second driving member 850 to perform compression. When the externally input heat energy is able to drive the first driving member 820 to work, the second driving member 850 is turned off, and the first driving member 820 is used to drive the first compressor 310 and the second compressor 330.

Preferably, the first driving member 820, the second driving member 850, and the first compressor 310 are arranged coaxially with the second compressor 330. That is, output shafts of the first driving member 820 and the second driving member 850 are collinear, and the first compressor 310 and the second compressor 330 are distributed along an axial direction of output shafts of the first driving member 820 and the second driving member 850. In this way, the axial thrust can be balanced, the axial and radial vibration can be reduced, and the whole device can run more smoothly with less vibration and noise.

Preferably, the first driving member 820, the second driving member 850, the first compressor 310, and the second compressor 330 are all sealed with dry gas.

Alternatively, before the storing energy is performed, the driving assembly 800 may be started to work in advance, and when the first driving member 820 can work, the energy storage assembly 300 and other components can be started. In this way, it is not necessary to provide the second driving member 850.

In addition, circulation pumps and other components are provided on each of the above pipelines to realize the directional flow of carbon dioxide and heat exchanging medium.

In some embodiments, the carbon dioxide flowing out of the first compressor 310 can also be diverted. A part of the carbon dioxide flows to the first energy storage heat exchanger 320, a part of the carbon dioxide flows to the energy input member 810, absorbs the external heat energy through the energy input member 810, and then flows to the first driving member 820. The carbon dioxide impacts the blade of the first driving member 820 to enable the first driving member 820 to work, and then the first compressor 310 is driven to work through the first driving member 820. The carbon dioxide flowing out of the first driving member 820 is cooled by the driving circulation cooler 830, and combined with the carbon dioxide flowing out of the gas storage reservoir 100, and flows to the first compressor 310. Alternatively, the carbon dioxide flowing out of the second compressor 330 may be diverted, a part of the carbon dioxide flows to the second energy storage heat exchanger 340, a part of the carbon dioxide flows to the energy input member 810.

In this way, there is no need to provide another driving medium, and the carbon dioxide in the system can be directly used as the driving medium, which is more convenient.

During storing energy, a first valve 610, a third valve 630, and a fifth valve 650 are opened, a second valve 620 and a fourth valve 640 are closed, and the second driving member 850 and the driving circulation pump 840 are activated. The driving medium is pressurized by the driving circulation pump 840 and flows to the energy input member 810 through the first driving circulation pipeline 861, and the temperature of the driving medium is increases after absorbing external heat energy through the energy input member 810. The first driving member 820 is a turbine. The driving medium in the high temperature and high-pressure state flows to the first driving member 820 through the second driving circulation pipeline 862, and the driving medium impacts the blades of the turbine and pushing the rotor to rotate, thereby driving the shaft of the turbine to rotate and enabling the first compressor 310 and the second compressor 330 to work. The temperature and pressure of the driving medium flowing out from the first driving member 820 are decreased, but the temperature is still too high. Therefore, the driving medium flows to the driving circulation cooler 830 through the third driving circulation pipeline 863, and the driving medium flows to the driving circulation cooler 830 through the third driving circulation pipeline 863, and is cooled by the driving circulation cooler 830 to meet the requirement of the temperature of an inlet of the driving circulation pump 840. After being cooled by the driving circulation cooler 830, the driving medium enters the driving circulation pump 840 again through the fourth driving circulation pipeline 864. By repeating the above process, output power can be continuously provided to the first compressor 310 and the second compressor 330.

The gaseous carbon dioxide in the normal temperature and pressure state flows out from the gas storage reservoir 100 and flows to the first compressor 310 through the first energy storage pipeline 361. The gaseous carbon dioxide is first compressed by the first compressor 310 to increase its pressure. During the compression process, heat is generated to increase the temperature of the carbon dioxide. After being compressed by the first compressor 310, the carbon dioxide flows to the first energy storage heat exchanger 320 through the second energy storage pipeline 362, and transfers the heat generated during the compression process to the first energy storage heat exchanger 320. The first energy storage heat exchanger 320 transfers the heat to the heat exchanging medium. The carbon dioxide flowing out from the first energy storage heat exchanger 320 flows to the second compressor 330 through the third energy storage pipeline 363, and is compressed for a second time by the second compressor 330 to further increase its pressure. During the compression process, heat is generated to increase the temperature of the carbon dioxide. After being compressed by the second compressor 330, the carbon dioxide flows to the second energy storage heat exchanger 340 through the fourth energy storage pipeline 364, and the heat generated during the compression process is transferred to the second energy storage heat exchanger 340. The second energy storage heat exchanger 340 transfers heat to the heat exchanging medium. After the heat exchange is achieved, the high-pressure gaseous carbon dioxide flows to the condenser 350 through the fifth energy storage pipeline 365, and is condensed by the condenser 350 to be converted into liquid carbon dioxide. The liquid carbon dioxide flows to the liquid storage tank 200 through the sixth energy storage pipeline 366 to complete the process of storing energy.

When releasing energy, the second valve 620 and the fourth valve 640 are opened, and the first valve 610 and the third valve 630 are closed. The high-pressure liquid carbon dioxide flows out from the liquid storage tank 200, and flows to the evaporator 410 through the first energy releasing pipeline 471, then the liquid carbon dioxide is evaporated into a gaseous state through the evaporator 410. The gaseous carbon dioxide flows to the first energy releasing heat exchanger 420 through the second energy releasing pipeline 472. A part of the heat stored in the heat exchanging medium during the process of storing energy is transferred to the carbon dioxide flowing through the first energy releasing heat exchanger 420 through the first energy releasing heat exchanger 420, and the carbon dioxide absorbs the part of the heat to increase the temperature of the carbon dioxide. The high-temperature gaseous carbon dioxide flows to the first expander 430 through the third energy releasing pipeline 473, and is expanded in the first expander 430 to achieve energy output, thereby driving a first generator 491 to generate electricity. After flowing out of the first expander 430, the carbon dioxide flows to the second energy releasing heat exchanger 440 through the fourth energy releasing pipeline 474. A part of the heat stored in the heat exchanging medium during the process of storing energy is transferred via the second energy releasing heat exchanger 440 to the carbon dioxide flowing through the second energy releasing heat exchanger 440. The carbon dioxide absorbs the part of heat to increase the temperature of the carbon dioxide. The high-temperature gaseous carbon dioxide flows to the second expander 450 through the fifth energy releasing pipeline 475, and is expanded in the second expander 450 to achieve energy output, thereby driving a second generator 492 to generate electricity.

After releasing energy, the pressure and temperature of carbon dioxide are reduced, but the temperature is still higher than a storage temperature required by the gas storage reservoir 100. Therefore, the carbon dioxide flowing from the second expander 450 flows to the energy releasing cooler 460 through the sixth energy releasing pipeline 476, and the carbon dioxide is cooled by the energy releasing cooler 460 to meet the storage temperature required by the gas storage reservoir 100. The cooled carbon dioxide flows to the gas storage reservoir 100 through the seventh energy releasing pipeline 477 to complete the entire process of releasing energy.

In the above process, the thermal energy stored in the heat exchange assembly 500 is merged into the high-pressure carbon dioxide, and the carbon dioxide is expanded in the first expander 430 and the second expander 450, thereby releasing the pressure energy together with the thermal energy and converting them into mechanical energy.

During the above storing energy and releasing energy process, a heat exchange medium circulating pump 550, a heat exchange medium circulating pump 551, the third valve 630 and the fourth valve 640 are opened, and the heat exchanging medium circulates between the cold storage tank 510 and the heat storage tank 520 to realize the temporary storage and release of energy. Specifically, the energy is temporarily stored in the heat exchanging medium in the form of heat energy. During the process of storing energy, after the low-temperature heat exchanging medium flows out of the cold storage tank 510, a part of the heat exchanging medium flows to the first heat exchange pipeline 541, and another part of the heat exchanging medium flows to the third heat exchange pipeline 543. The heat exchanging medium in the first heat exchange pipeline 541 flows to the second energy storage heat exchanger 340 for heat exchange, and the heat exchanging medium absorbs the heat in the carbon dioxide compressed for the second time to increase the temperature of the part of the heat exchanging medium, and then the heat exchanging medium flows to the heat storage tank 520 through the second heat exchange pipeline 542, and the heat is temporarily stored into the heat storage tank 520. The low-temperature heat exchanging medium in the third heat exchange pipeline 543 flows to the first energy storage heat exchanger 320 for heat exchange, the low-temperature heat exchanging medium absorbs the heat in the carbon dioxide compressed for the first time to increase the temperature of the part of the heat exchanging medium, and then the heat exchanging medium flows to the heat storage tank 520 through the fourth heat exchange pipeline 544, and the heat is temporarily stored into the heat storage tank 520.

When releasing energy, after the high temperature heat exchanging medium flows out of the heat storage tank 520, a part of the high temperature heat exchanging medium flows to the fifth heat exchange pipeline 545, and another part of the high temperature heat exchanging medium flows to the seventh heat exchange pipeline 547. The heat exchanging medium in the fifth heat exchange pipeline 545 flows to the second energy releasing heat exchanger 440 for heat exchange, and transfers heat to the carbon dioxide flowing through the second energy releasing heat exchanger 440 to increase the temperature of the carbon dioxide. After the heat exchange is completed, the temperature of the heat exchanging medium is decreased, and the cooled heat exchanging medium flows to the cold storage tank 510 through the sixth heat exchange pipeline 546. Although the temperature of the heat exchanging medium decreases after heat exchange, the temperature of the heat exchanging medium is still higher than a temperature range required by the cold storage tank 510. Therefore, when the part of the heat exchanging medium flows through the heat exchange medium cooler 530 through the sixth heat exchange pipeline 546, the heat exchanging medium is cooled again by the heat exchange medium cooler 530 to meet the requirement of the temperature of the cold storage tank 510.

The heat exchanging medium in the seventh heat exchange pipeline 547 flows to the first energy releasing heat exchanger 420 for heat exchange, and transfers heat to the carbon dioxide flowing through the first energy releasing heat exchanger 420 to increase the temperature of the carbon dioxide. After the heat exchange is completed, the temperature of the heat exchanging medium decreases, and the cooled heat exchanging medium flows to the cold storage tank 510 through the eighth heat exchange pipeline 548. Although the temperature of the heat exchanging medium decreases after heat exchange, the temperature of the heat exchanging medium is still higher than the temperature range required by the cold storage tank 510. Therefore, when the part of the heat exchanging medium flows through the heat exchange medium cooler 530 through the eighth heat exchange pipeline 548, the heat exchanging medium is cooled again by the heat exchange medium cooler 530 to meet the requirement of the temperature of the cold storage tank 510.

In addition, in some embodiments, the first valve 610, the second valve 620, the third valve 630, the fourth valve 640, and the fifth valve 650 may all be opened, and storing energy and releasing energy are performed simultaneously.

Preferably, in some embodiments, after the heat exchanging medium is cooled by the heat exchange medium cooler 530, the released heat can be recycled for evaporating the carbon dioxide, so as to reduce energy waste and improve energy utilization.

Specifically, the heat exchange medium cooler 530 may be connected to the evaporator 410 to transfer the heat released by the heat exchange medium cooler 530 when cooling the heat exchanging medium to the evaporator 410 for evaporating the carbon dioxide. The heat exchange medium cooler 530 and the evaporator 410 may be directly connected or indirectly connected through other components.

It should be noted that, if only the heat exchange medium cooler 530 is configured to evaporate the heat released during the cooling of the heat exchanging medium, there may be insufficient heat. Therefore, the external heat source can also be used to supplement heat, so that the evaporation process can be carried out smoothly.

Preferably, the supplementary external heat source may be geothermal heat, solar heat, thermal energy generated by waste incineration, waste heat generated during industrial production, etc. By using the external heat source, energy waste can be reduced, and additional heating is not required, which can reduce costs.

Further, in some embodiments, during the process of storing energy, the heat released during condensation through the condenser 350 can be recycled. During the process of releasing energy, the part of the heat is supplied to the evaporator 410 for evaporating the carbon dioxide, so as to reduce energy waste and improve energy utilization.

Specifically, the condenser 350 may be connected to the evaporator 410 to collect the heat released during the condensation of the carbon dioxide and transfer the heat to the evaporator 410 for evaporating the carbon dioxide. The condenser 350 and the evaporator 410 may be directly connected or indirectly connected through other components.

It should be noted that, if only the heat released by condenser 350 is used for evaporation, there may be insufficient heat. Therefore, the external heat source can also be used to supplement heat, so that the evaporation process can be carried out smoothly.

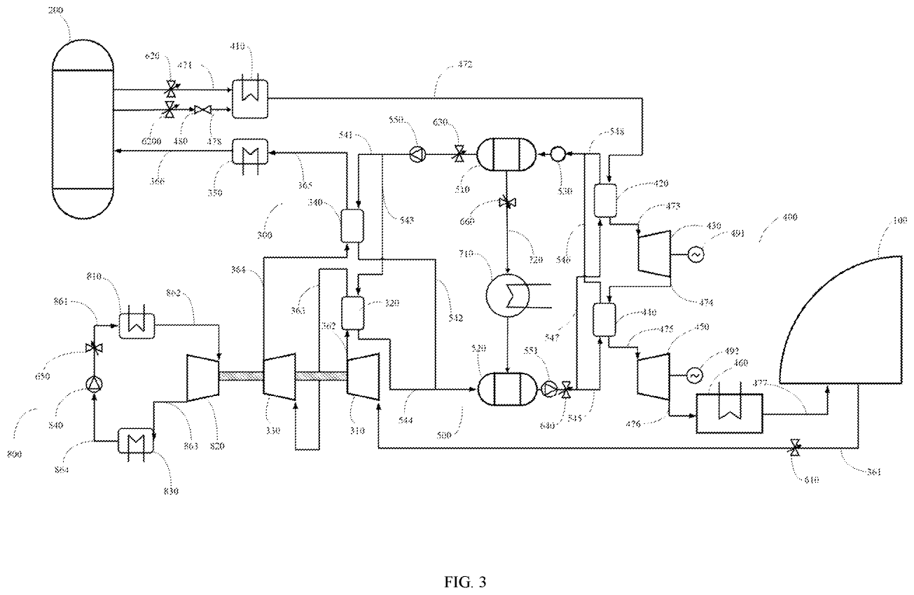

Referring to FIG. 3, which shows a schematic view of the multi-stage compression energy storage device configured to convert thermal energy to mechanical energy based on CO₂ gas-liquid phase transition according to another embodiment of the present disclosure. In some embodiments, the first energy releasing pipeline 471 and an eighth energy releasing pipeline 478 are provided between the evaporator 410 and the liquid storage tank 200. A second valve 620 is provided on the first energy releasing pipeline 471, and a throttle expansion valve 480 and a seventh valve 6200 are provided on the eighth energy releasing pipeline 478. When the second valve 620 is opened and the seventh valve 6200 is closed, the first energy releasing pipeline 471 is conducted. When the seventh valve 6200 is opened and the second valve 620 is closed, the eighth energy releasing pipeline 478 is conducted. In the process of releasing energy, when the eighth energy releasing pipeline 478 is selected to be opened, the high-pressure liquid carbon dioxide flowing out of the liquid storage tank 200 is expanded and depressurized through the throttle expansion valve 480, and then the liquid carbon dioxide flows to the evaporator 410.

Compared with converting the carbon dioxide from the liquid state to the gas state by merely increasing the temperature, configuring the throttle expansion valve 480 for depressurization is conducive to convert the carbon dioxide from the liquid state to the gas state.

Preferably, when the throttling expansion valve 480 is used, the evaporator 410 and the condenser 350 can be combined to form a phase change heat exchanger. The phase change heat exchanger includes an evaporation portion and a condensation portion. The evaporation portion is connected to the condensation portion by pipelines, and the heat released during condensation of the condensation portion is transferred to the evaporation portion inside the phase change heat exchanger. After the evaporator 410 and condenser 350 are combined to one component, the heat transferring is completed inside the phase change heat exchanger, which can reduce the loss of heat during transferring and further improve the energy utilization. It should be noted that when storing energy and releasing energy are performed at the same time, the heat transfer can be realized in the above way. If they cannot be performed at the same time, the energy needs to be stored first, and then supplied to the evaporator 410 when the carbon dioxide is evaporated.

As mentioned above, during the process of releasing energy, the carbon dioxide from the second expander 450 flows to the energy releasing cooler 460 through the sixth energy releasing pipeline 476, and the carbon dioxide is cooled by the energy releasing cooler 460, so that the temperature of the carbon dioxide can meet the requirement of the gas storage reservoir 100. When the energy releasing cooler 460 performs cooling and heat exchange, the heat is released. Preferably, in some embodiments, the part of heat can be recycled for evaporating the carbon dioxide to reduce energy waste and improve energy utilization.

Preferably, the heat released during the condensation of the carbon dioxide and the heat released by the energy releasing cooler 460 can be supplied to the evaporator 410.

Specifically, the energy releasing cooler 460 and the condenser 350 may be connected to the evaporator 410, and the heat released during the cooling and heat exchange of the energy releasing cooler 460 and the heat released during the condensation of the condenser 350 can be transferred to the evaporator 410 for evaporating the carbon dioxide. The energy releasing cooler 460 and the evaporator 410 may be directly connected or indirectly connected through other components. The condenser 350 and the evaporator 410 may be directly connected or indirectly connected through other components.

For example, the heat transferring between the energy releasing cooler 460 and the evaporator 410 is achieved through a pool. A first recovery pipeline and a second recovery pipeline are provided between the pool and the energy releasing cooler 460. A third recovery pipeline and a fourth recovery pipeline are provided between the pool and the evaporator 410. A fifth recovery pipeline and a sixth recovery pipeline are provided between the pool and the condenser 350. The pool and the above-mentioned pipelines are provided with thermal insulation materials to insulate the water therein.

A part of the water in the pool flows to the condenser 350 through the fifth recovery pipeline to absorb the heat released by the condenser 350, and after the temperature of the water is increased, the water flows to the pool through the sixth recovery pipeline. At the same time, another part of the water in the pool flows to the energy releasing cooler 460 through the first recovery pipeline to absorb the heat released by the energy releasing cooler 460, and after the water temperature rises, the water flows to the pool through the second recovery pipeline.

When the carbon dioxide is to be evaporated, the water with a higher temperature in the pool flows to the evaporator 410 through the third recovery pipeline to provide heat for evaporating the carbon dioxide. After the water flows through the evaporator 410, the temperature of the water decreases, and the cooled water flows to the pool through the fourth recovery pipeline.

In the above process, in addition to using water, other substances can also be used for heat collection.

In addition, circulating pumps and other components are provided on the first recovery pipeline, the second recovery pipeline, the third recovery pipeline, the fourth recovery pipeline, the fifth recovery pipeline and the sixth recovery pipeline to enable the water to circulate in the pool.

When the heat released by the energy releasing cooler 460 and the condenser 350 is continuously transferred to the pool, the temperature of the water in the pool may be continuously increased. When the evaporator 410 continuously absorbs the heat in the pool, the temperature of the water in the pool may be continuously reduced. Therefore, preferably, the pool is in a constant temperature state.

Specifically, the pool is further connected to a thermostatic controller, a temperature sensor, a heater, a radiator, and other components. The temperature sensor detects the temperature of the water in the pool and transmits the temperature of the water to the thermostatic controller. When the heat released by the energy releasing cooler 460 and the condenser 350 enables the temperature of the water to be increased too much, which is higher than a preset maximum value, the thermostatic controller controls the radiator to dissipate heat from the pool. When the heat absorbed by evaporator 410 enables the temperature of the water to be reduced too much, which is lower than a preset minimum value, the thermostatic controller controls the heater to heat the pool.

In some embodiments, the heat released by the condenser 350, the energy releasing cooler 460 and the heat exchange medium cooler 530 may be supplied to the evaporator 410. The specific setting manner is similar to the above embodiment, and will not be repeated here. The condenser 350, the energy releasing cooler 460 and the heat exchange medium cooler 530 can supply heat individually, or any two of them supply the heat.

When the heat supplied to the evaporator 410 by the condenser 350, the energy releasing cooler 460, and the heat exchange medium cooler 530 is still insufficient, the external heat source can be used to supplement the heat. Specifically, when using the external heat source to supplement heat, the heat can be directly supplemented to the evaporator 410. Alternatively, heat can be added to the heat exchanging medium of the heat exchanging circuit.

When adding heat to the evaporator 410, the external heat source may be directly connected to the evaporator 410.

When the heat is added to the heat exchanging medium of the heat exchanging circuit, a heating pipe 720 may be provided between the cold storage tank 510 and the heat storage tank 520, and an auxiliary heating member 710 can be provided on the heating pipe 720. The sixth valve 660 is opened, and a part of the heat exchanging medium flowing out of the cold storage tank 510 flows to the auxiliary heating member 710 through the heating pipe 720. The auxiliary heating member 710 heats the part of the heat exchanging medium to absorb external heat, so that the amount of heat reaching the heat exchange medium cooler 530 is increased, that is, the amount of heat that can be supplied to the evaporator 410 is increased.

Preferably, the heat source at the auxiliary heating member 710 may be some waste heat, for example, the heat released when castings or forgings are cooled in a foundry or forging plant, or may be the heat released during chemical reactions in some chemical plants. By using waste heat as the external heat source, energy waste can be reduced, and additional heating is not required, which can reduce costs.

Preferably, a plurality of groups of the above-mentioned energy storage assembly 300, energy releasing assembly 400, heat exchange assembly 500 and driving assembly 800 can be provided between the gas storage reservoir 100 and the liquid storage tank 200, and each group of the energy storage assembly 300, energy releasing assembly 400, heat exchange assembly 500 and driving assembly 800 is arranged in the manner in the above-mentioned embodiment. When in use, if any one component in one group fails, another group can work, which can reduce the downtime rate of the device and improve working reliability of the device.

Although the respective embodiments have been described one by one, it shall be appreciated that the respective embodiments will not be isolated. Those skilled in the art can apparently appreciate upon reading the disclosure of this application that the respective technical features involved in the respective embodiments can be combined arbitrarily between the respective embodiments as long as they have no collision with each other. Of course, the respective technical features mentioned in the same embodiment can also be combined arbitrarily as long as they have no collision with each other.

The foregoing descriptions are merely specific embodiments of the present disclosure, but are not intended to limit the protection scope of the present disclosure. Any variation or replacement readily figured out by a person skilled in the art within the technical scope disclosed in the present disclosure shall all fall within the protection scope of the present disclosure. Therefore, the protection scope of the present disclosure shall be subject to the protection scope of the appended claims.

1. A multi-stage compression energy storage device configured to convert thermal energy to mechanical energy based on CO₂ gas-liquid phase transition, multi-stage compression energy storage device comprising:
a gas storage reservoir configured to store gaseous carbon dioxide, and a volume of the gas storage reservoir being variable;
a liquid storage tank configured to store liquid carbon dioxide;
an energy storage assembly configured to store energy and provided between the gas storage reservoir and the liquid storage tank, wherein the energy storage assembly comprises a condenser and at least two compression energy storage members, each compression energy storage member comprises a compressor configured to compress the carbon dioxide and an energy storage heat exchanger, and the condenser is configured to condense the carbon dioxide;
an energy releasing assembly provided between the gas storage reservoir and the liquid storage tank and comprising an evaporator and at least one expansion energy releasing member, wherein the expansion energy releasing member comprises an energy releasing heat exchanger and an expander, the evaporator is configured to evaporate the carbon dioxide, and the expander is configured to release energy;
a heat exchange assembly connected to the energy storage heat exchanger and the energy releasing heat exchanger, wherein the energy storage heat exchanger is configured to temporarily store the energy generated by the energy storage assembly into the heat exchange assembly, and the energy releasing heat exchanger is configured to receive the energy temporarily stored by the heat exchange assembly; and
a driving assembly comprising an energy input member and a first driving member, wherein the energy input member absorbs external heat energy to drive the first driving member to work, and the first driving member is configured to drive the compressor to work.

2. The multi-stage compression energy storage device according to claim 1, wherein the driving assembly further comprises a second driving member connected to the compressor, when the first driving member is not activated, the second driving member is capable of driving the compressor to work.

3. The multi-stage compression energy storage device according to claim 1, wherein the compressors of the plurality of compression energy storage members are distributed along an axial direction of an output shaft of the first driving member.

4. The multi-stage compression energy storage device according to claim 1, wherein the driving assembly further comprises a driving circulation cooler and a driving circulation pump; the energy input member, the first driving member, the driving circulation cooler, and the driving circulation pump form a driving circulation circuit, driving medium is provided in the driving circulation circuit, the driving circulation pump is configured to drive the driving medium to circulate in the driving circulation circuit, the driving medium absorbs the external heat energy through the energy input member and drives the first driving member to work, the driving circulation cooler is configured to cool the driving medium flowing out of the first driving member.

5. The multi-stage compression energy storage device according to claim 1, wherein the energy storage assembly comprises a first compressor, a first energy storage heat exchanger, a second compressor, and a second energy storage heat exchanger, the first compressor is connected to the gas storage reservoir, the first energy storage heat exchanger is connected to the first compressor, the second compressor is connected to the first energy storage heat exchanger, and the second energy storage heat exchanger is connected to the second compressor, the condenser is connected to the second energy storage heat exchanger, and the liquid storage tank is connected to the condenser.

6. The multi-stage compression energy storage device according to claim 1, wherein the energy releasing assembly comprises a first expander, a second expander, a first energy releasing heat exchanger, a second energy releasing heat exchanger and an energy releasing cooler, and the evaporator is connected to the liquid storage tank, the first energy releasing heat exchanger is connected to the evaporator, the first expander is connected to the first energy releasing heat exchanger, the second energy releasing heat exchanger is connected to the first expander, the second expander is connected to the second energy releasing heat exchanger, the energy releasing cooler is connected to the second expander, the gas storage reservoir is connected to the energy releasing cooler, and the energy releasing cooler is configured to cool the carbon dioxide in the gas storage reservoir.

7. The multi-stage compression energy storage device according to claim 6, wherein the energy releasing cooler is connected to the evaporator.

8. The multi-stage compression energy storage device according to claim 1, wherein the energy releasing assembly further comprises a throttle expansion valve provided between the liquid storage tank and the evaporator, the throttle expansion valve is configured to depressurize the carbon dioxide flowing out of the liquid storage tank, and the evaporator is connected to the condenser.

9. The multi-stage compression energy storage device according to claim 1, wherein the heat exchange assembly comprises a cold storage tank and a heat storage tank, and heat exchanging medium is provided in the cold storage tank and the heat storage tank, the cold storage tank and the heat storage tank form a heat exchanging circuit between the energy storage assembly and the energy releasing assembly, the heat exchanging medium is capable of flowing in the heat exchanging circuit, when the heat exchanging medium flows from the cold storage tank to the heat storage tank, the heat exchanging medium is capable of storing a part of the energy generated by the energy storage assembly, and when the heat exchanging medium flows from the heat storage tank to the cold storage tank, the stored energy is transferred to the energy releasing assembly.

10. The multi-stage compression energy storage device according to claim 1, wherein the heat exchange assembly further comprises a heat exchange medium cooler configured to cool the heat exchanging medium entering the cold storage tank, and the heat exchange medium cooler is connected to the evaporator.

11. The multi-stage compression energy storage device according to claim 1, wherein an auxiliary heating member is provided between the cold storage tank and the heat storage tank, and a part of the heat exchanging medium is capable of flowing into the heat storage tank after being heated by the auxiliary heating member.

12. The multi-stage compression energy storage device according to claim 1, wherein the gas storage reservoir is a flexible gas film storage reservoir.
